(19) United States
(12) Patent Application Publication
(10) Pub. No.: US 2019/0377336 A1
(43) Pub. Date: Dec. 12, 2019

(54) METHOD AND SYSTEM FOR DISTRIBUTED LEDGER TECHNOLOGY COMMUNICATIONS FOR VEHICLES

(71) Applicant: GENERAL MOTORS LLC, Detroit, MI (US)

(72) Inventors: Paul A. Avery, Round Rock, TX (US); Yehenew G. Mengistu, Sterling Heights, MI (US); David H. Clifford, Royal Oak, MI (US)

(73) Assignee: GENERAL MOTORS LLC, Detroit, MI (US)

(21) Appl. No.: 16/006,371

(22) Filed: Jun. 12, 2018

(51) Int. Cl. G05D 1/00; G06F 17/30; G07C 5/00; G05D 1/02; H04L 29/08

(52) U.S. Cl. CPC G05D 1/0022; G06F 17/30345; G07C 5/008; G05D 2201/0213; H04L 67/104; H04L 67/12; G05D 1/021

(57) ABSTRACT

In various embodiments, methods and systems are provided for vehicles for utilizing distributed ledger technology communications for vehicles. In certain embodiments, one or more sensors are disposed onboard the vehicle and are configured to provide sensor data pertaining to operation of the vehicle. A transceiver is disposed onboard the vehicle, and is configured to receive, using distributed ledger technology (DLT), peer network data from a peer network having, as actors, the vehicle as well as a plurality of other actors that are disposed remote from the vehicle, and that together form the peer network. The processor is disposed onboard the vehicle, and is configured to provide instructions for taking a vehicle action for the vehicle using the peer network data and the sensor data.

### TECHNICAL FIELD

The technical field generally relates to vehicles and, more specifically, to methods and systems for utilizing distributed ledger technology communications for vehicles.

### BACKGROUND

Many vehicles today are able to communicate in certain manners with other vehicles and/or other systems. However, existing communication techniques may not always be optimal.

Accordingly, it is desirable to provide improved methods and systems for vehicles for communicating with other vehicles and other participants of a peer network utilizing distributed ledger technology communications. Furthermore, other desirable features and characteristics of the present invention will become apparent from the subsequent detailed description of the invention and the appended claims, taken in conjunction with the accompanying drawings and this background of the invention.

### SUMMARY

In accordance with an exemplary embodiment, a method is provided that includes: receiving sensor data pertaining to operation of a vehicle, via one or more sensors that are disposed onboard the vehicle; receiving, using distributed ledger technology (DLT), peer network data, via a transceiver that is onboard the vehicle, from a peer network having, as actors, the vehicle as well as a plurality of other actors that are disposed remote from the vehicle, and that together form the peer network; and taking a vehicle action for the vehicle, via instructions provided by a processor that is disposed onboard the vehicle, using the peer network data and the sensor data.

Also in one embodiment, the method further includes: generating, via the processor, a data object using the sensor data; and posting the data object on the peer network, via the transceiver, in accordance with further instructions provided by the processor.

Also in one embodiment, the step of taking the vehicle action includes taking automatic control of one or more vehicle modules, via the instructions provided by the processor based on the peer network data and the sensor data.

Also in one embodiment, the method further includes verifying a source of the peer network data from the plurality of other actors; and the step of taking the vehicle action includes taking the vehicle action based also on the verifying of the source of the peer network data.

Also in one embodiment, the step of taking the vehicle action includes determining a recommended vehicle action from the peer network data; and the step of taking the vehicle action includes: if the source of the peer network data includes a verified source, then automatically implementing the recommended vehicle action, via the instructions provided by the processor; and if the source of the peer network includes an unverified source, then: determining whether the recommended vehicle action is consistent with the sensor data; and implementing the recommended vehicle action on a further condition that the recommended vehicle action is consistent with the sensor data.

Also in one embodiment, the method further includes transforming the peer network data into a data object, via the processor; and updating a local ledger on a memory that is disposed onboard the vehicle using the data object, via the instructions provided by the processor.

Also in one embodiment, the step of transforming the peer network data into the data object includes transforming the peer network data into a data block, via the processor; and the step of updating the local ledger includes updating a local copy of the ledger/blockchain on the memory that is disposed onboard the vehicle using the data block, via the instructions provided by the processor.

In another exemplary embodiment, a system is provided that includes a vehicle interface module, a communication module, and a manager module. The vehicle interface module is configured to receive sensor data pertaining to operation of a vehicle, via one or more sensors that are disposed onboard the vehicle. The communication module is configured to receive, using distributed ledger technology (DLT), peer network data, via a transceiver that is onboard the vehicle, from a peer network having, as actors, the vehicle as well as a plurality of other actors that are disposed remote from the vehicle, and that together form the peer network. The manager module is configured to take a vehicle action for the vehicle, via instructions provided by a processor that is disposed onboard the vehicle, using the peer network data and the sensor data.

Also in one embodiment, the manager module is configured to: generate, via the processor, a data object using the sensor data; and provide further instructions to post the data object on the peer network, via the communication module.

Also in one embodiment, the manager module is configured to take automatic control of one or more vehicle modules, via the instructions provided by the processor based on the peer network data and the sensor data.

Also in one embodiment, the manager module is configured to: verify a source of the peer network data from the plurality of other actors; and take the vehicle action based also on the verifying of the source of the peer network data.

Also in one embodiment, the manager module is configured to: determine a recommended vehicle action from the peer network data; if the source of the peer network data includes a verified source, then automatically implement the recommended vehicle action, via the instructions provided by the processor; and if the source of the peer network includes an unverified source, then: determine whether the recommended vehicle action is consistent with the sensor data; and implement the recommended vehicle action on a further condition that the recommended vehicle action is consistent with the sensor data.

Also in one embodiment, the manager module is configured to: transform the peer network data into a data object, via the processor; and update a local ledger on a memory that is disposed onboard the vehicle using the data object, via the instructions provided by the processor.

Also in one embodiment, wherein the manager module is configured to: transform the peer network data into a data block, via the processor; and update a blockchain on the memory that is disposed onboard the vehicle using the data block, via the instructions provided by the processor.

In another exemplary embodiment, a vehicle is provided that includes a body, a propulsion system, one or more sensors, a transceiver, and a processor. The propulsion system is configured to generate movement of the body. The one or more sensors are disposed onboard the vehicle and configured to provide sensor data pertaining to operation of the vehicle. The transceiver is disposed onboard the vehicle and configured to receive, using distributed ledger technology (DLT), peer network data from a peer network having, as actors, the vehicle as well as a plurality of other actors that are disposed remote from the vehicle, and that together form the peer network. The processor is disposed onboard the vehicle and configured to provide instructions for taking a vehicle action for the vehicle using the peer network data and the sensor data.

Also in one embodiment, the processor is configured to: generate a data object using the sensor data; and provide instructions to post the data object on the peer network via the transceiver.

Also in one embodiment, the processor is configured to take automatic control of one or more vehicle modules based on the peer network data and the sensor data.

Also in one embodiment, the processor is configured to: verify a source of the peer network data from the plurality of other actors; determine a recommended vehicle action from the peer network data; if the source of the peer network data includes a verified source, then automatically implement the recommended vehicle action; and if the source of the peer network includes an unverified source, then: determine whether the recommended vehicle action is consistent with the sensor data; and implement the recommended vehicle action on a further condition that the recommended vehicle action is consistent with the sensor data.

Also in one embodiment, the processor is configured to: transform the peer network data into a data object; and provide instructions to update a local ledger on a memory that is disposed onboard the vehicle using the data object.

Also in one embodiment, the processor is configured to: transform the peer network data into a data block; and provide instructions to update a blockchain on the memory that is disposed onboard the vehicle using the data block.

### DESCRIPTION OF THE DRAWINGS

The present disclosure will hereinafter be described in conjunction with the following drawing figures, wherein like numerals denote like elements, and wherein:

FIG. 1 is a functional block diagram of a vehicle that includes a control system for controlling and implementing distributed ledger communications for the vehicle;

FIG. 2 is a block diagram of modules of the vehicle of FIG. 1, including the control system of FIG. 1 along with steps implemented by the modules, in accordance with exemplary embodiments; and

FIG. 3 is a block diagram of exemplary hardware connectivity and process flow for the control system of FIGS. 1 and 2, in accordance with exemplary embodiments.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

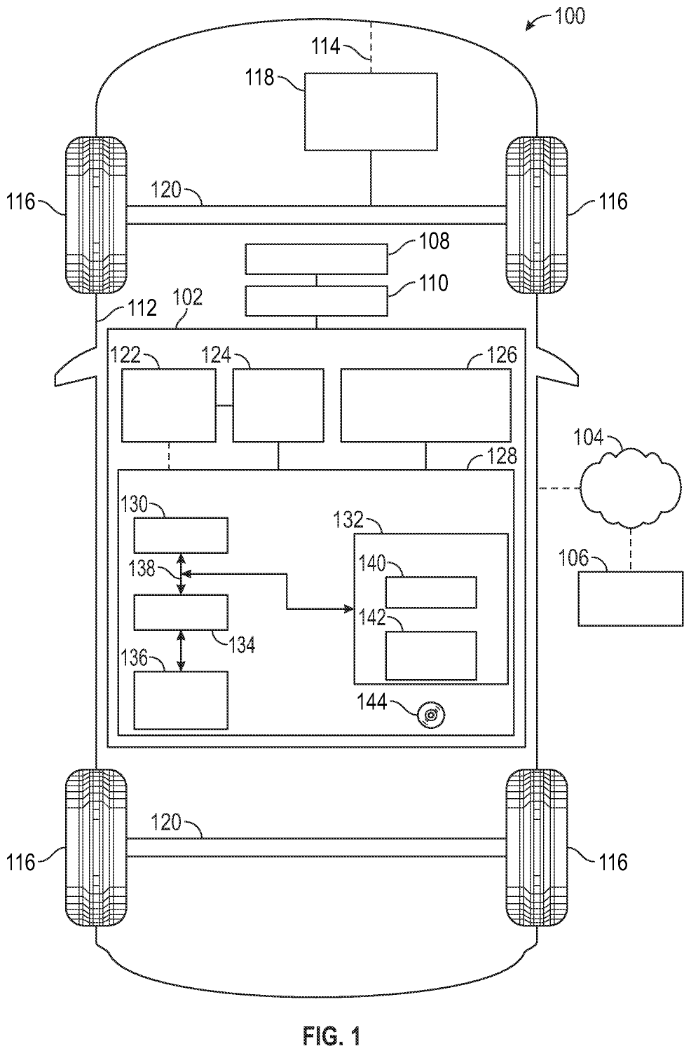

FIG. 1 illustrates a vehicle 100, according to an exemplary embodiment. As described in greater detail further below, the vehicle 100 includes a control system 102 for controlling and implementing distributed ledger communications for the vehicle 100. Also as described in greater detail below, the control system 102 facilitates communications between the vehicle 100 and a peer network 104 having various other participants 106. Also in various embodiments, the control system 102 is coupled to various vehicle modules 108 (e.g., braking control, engine control, transmission control, instrument pack, lighting, climate control, and so on, in certain embodiments) via one or more vehicle buses 110 (e.g., one or more vehicle CAN buses, in certain embodiments).

As discussed in greater detail further below, the control system 102 controls, maintains, and implements data using distributed ledger technology via communications with the peer network 104. In various embodiments, the distributed ledger technology (or “DLT”) allows multiple participants to participate in the data ecosystem. In various embodiments, the participants in the peer network 104 utilizing the DLT technology include the vehicle 100 as well as the other participants 106, which may include other vehicles on the road, infrastructure on or near the road (e.g., traffic lights, stop signs, other traffic signs, tunnels, bridges, road curbs, and so on), intelligent systems (e.g., IOT), server systems, cloud systems, and the like. In various embodiments, each of these participants has a copy of the last known information or the last known state of all participants in that system, and the DLT hosts or stores data from the various different participants in a database (e.g., on a central/remote database as well as local copies for the various participants, in certain embodiments) that shares or transacts the information via a programmatically addressable protocol. Also in such a DLT system, in various embodiments, each of the participants may request the ability to update the database/ledger from their local copy, and that public copy is distributed among the participants in that ledger system. Accordingly, in this framework, in certain embodiments, rather than having an authorized user make a transformation to the underlying array, instead the participant attempts to add a specific piece of information to the distributed array, and the participants in that system decide whether or not to accept or reject that particular data element. In various embodiments, the vehicle 100 (via the control system 102 thereof) provides this functionality along with the various other participants 106 in the peer network 104 of FIG. 1. In certain embodiments, a blockchain system is utilized as the DLT system; however, in other embodiments other DLT technologies may be utilized. In either case, in various embodiments, the vehicle 100 (along with the other participants 106 in the peer network 104) may request the ability to modify copies of the data that exists in a distributive fashion among the various participants.

In various embodiments, the vehicle 100 comprises an automobile. The vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain embodiments. In certain embodiments, the vehicle 100 may also comprise a motorcycle or other vehicle, and/or one or more other types of mobile platforms (e.g., a robot, a ship, and so on) and/or other systems.

The vehicle 100 includes a body 112 that is arranged on a chassis 114. The body 112 substantially encloses other components of the vehicle 100. The body 112 and the chassis 114 may jointly form a frame. The vehicle 100 also includes a plurality of wheels 116. The wheels 116 are each rotationally coupled to the chassis 114 near a respective corner of the body 112 to facilitate movement of the vehicle 100. In one embodiment, the vehicle 100 includes four wheels 116, although this may vary in other embodiments (for example for trucks and certain other vehicles).

A drive system 118 is mounted on the chassis 114, and drives the wheels 116, for example via axles 120. The drive system 118 preferably comprises a propulsion system. In certain exemplary embodiments, the drive system 118 comprises an internal combustion engine and/or an electric motor/generator, coupled with a transmission thereof. In certain embodiments, the drive system 118 may vary, and/or two or more drive systems 118 may be used. By way of example, the vehicle 100 may also incorporate any one of, or combination of, a number of different types of propulsion systems, such as, for example, a gasoline or diesel fueled combustion engine, a “flex fuel vehicle” (FFV) engine (i.e., using a mixture of gasoline and alcohol), a gaseous compound (e.g., hydrogen and/or natural gas) fueled engine, a combustion/electric motor hybrid engine, and an electric motor.

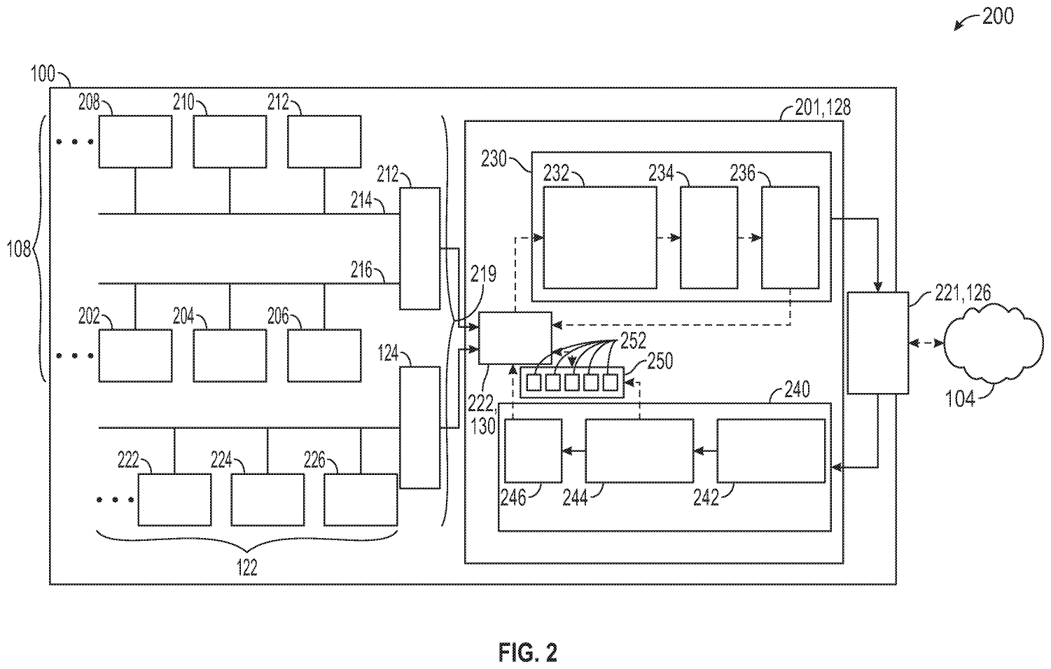

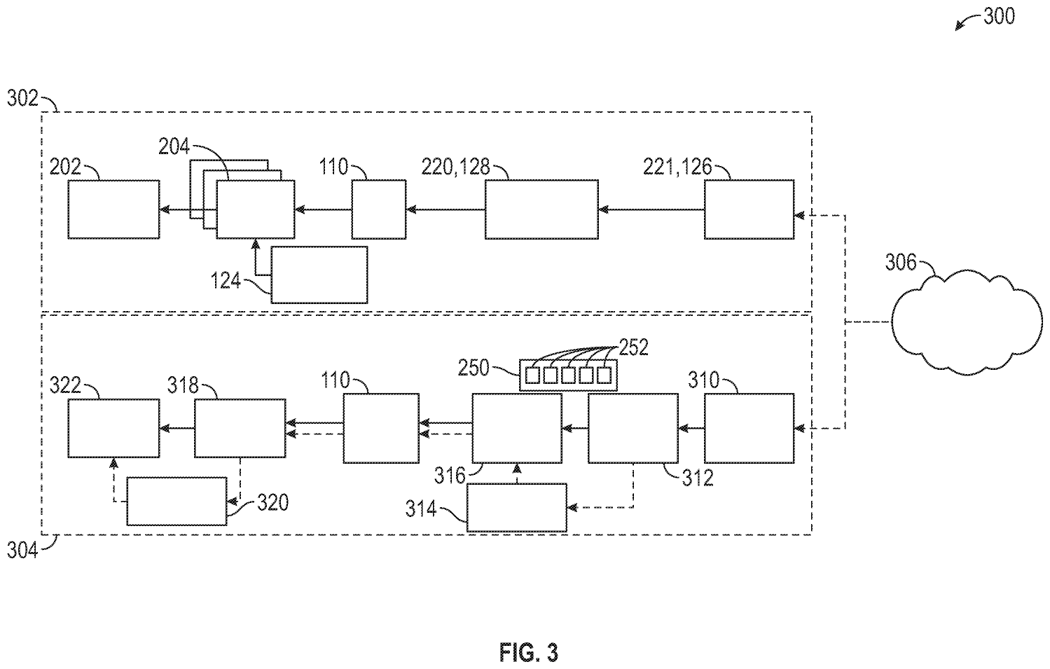

In various embodiments, the control system 102 controls communications with the peer network 104, for example for use in performing actions respect to one or more modules 108 of the vehicle 100 (e.g., vehicle braking, engine control, transmission control, climate control, lighting control, instrument control, and so on), among other vehicle actions. Also in various embodiments, the control system 102 receives data from the peer network 104 (e.g., including data pertaining to operation of the vehicle 100), transforms the data into a data object (e.g., a data block) that is consumable by a DLT of the peer network 104, transmits the transformed data to the peer network 104, and receives new information from the peer network 104 that is used to update a local ledger (e.g., a blockchain) on a vehicle as well as to implement one or more vehicle actions for the vehicle 100. In various embodiments, the control system 102 provides these and other functions in accordance with the steps of the processes set forth in FIGS. 2 and 3.

In various embodiments, the control system 102 is disposed within the body 112 of the vehicle 100. In one embodiment, the control system 102 is mounted on the chassis 114. In certain embodiments, the control system 102 and/or one or more components thereof may be disposed outside the body 112, for example on a remote server, in the cloud, or in a remote smart phone or other device where image processing is performed remotely. In addition, in certain embodiments, the control system 102 may be disposed within and/or as part of the vehicle modules 108, drive system 118, and/or within and/or or as part of one or more other vehicle systems. Also, as depicted in FIG. 1, in various embodiments the control system 102 is coupled to the vehicle modules 108 via the vehicle communication bus 110, and is further coupled to the peer network 104.

As depicted in FIG. 1, the control system 102 includes various sensors 122, a sensor interface 124, a transceiver 126, and a controller 128. In various embodiments, the sensors 122 include one or more cameras, radar sensors, infrared sensors, engine control sensors, and/or various other sensors pertaining to the various modules 108 and/or operation of the vehicle 100. Also in various embodiments, the sensor interface 124 facilitates communications between the sensors 122 and the controller 128.

In various embodiments, the transceiver 126 facilitates and provides communications between the vehicle 100 and the peer network 104. For example, in various embodiments, the transceiver 126 receives communications (e.g., including data pertaining to operation of the vehicle 100 and/or including recommendations for the vehicle 100) from the peer network 104 (e.g., from one or more other participants 106 of the peer network 104), and also provides communications from the vehicle 100 to the peer network 104 (e.g., for the vehicle 100 to post data objects onto the peer network 104). In certain embodiments, the transceiver 126 may also receive, provide, and/or facilitate communications between the controller 128 and the sensors 122 and/or vehicle modules 108. In various embodiments, the transceiver 126 may include a single transceiver and/or multiple transceivers, and may include one or more similar devices such as one or more receivers, transmitters, and/or communication modules (which will collectively be referred to as a “transceiver” for the purposes of this Application).

The controller 128 controls operation of the control system 102, and the communications with the peer network 104. In various embodiments, the controller 128 is coupled to the sensors 122 (e.g., via the sensor interface 124), the transceiver 126, the vehicle modules 108 (e.g., via the vehicle bus 110), and to the peer network 104. In various embodiments, the control system 102 receives data from the sensors 122, the vehicle modules 108, and the peer network 104, processes the data, controls vehicle actions using the data via the vehicle modules 108, updates a local ledger (e.g., blockchain) using the data, and controls the vehicle 100's communications with the peer network 104 (e.g., to post data objects onto the peer network 104). In various embodiments, the controller 128 provides these and other functions in accordance with the steps of the processes discussed further below in connection with FIGS. 2 and 3.

Also in one embodiment, the controller 128 is disposed within the control system 102, within the vehicle 100. In certain embodiments, the controller 128 (and/or components thereof, such as the processor 130 and/or other components) may be part of and/or disposed within one or more other vehicle components. Also in certain embodiments, the controller 128 may be disposed in one or more other locations of the vehicle 100. In addition, in certain embodiments, multiple controllers 128 may be utilized. In addition, in certain embodiments, the controllers 128 can be placed outside the vehicle, such as in a remote server, in the cloud or on a remote smart device.

As depicted in FIG. 1, the controller 128 comprises a computer system. In certain embodiments, the controller 128 may also include one or more of the sensors 122, the transceiver 126, one or more components thereof, and/or one or more other components of the vehicle 100. In addition, it will be appreciated that the controller 128 may otherwise differ from the embodiment depicted in FIG. 1. For example, the controller 128 may be coupled to or may otherwise utilize one or more remote computer systems and/or other control systems, for example as part of one or more of the above-identified vehicle 100 devices and systems.

In the depicted embodiment, the computer system of the controller 128 includes a processor 130, a memory 132, an interface 134, a storage device 136, and a bus 138. The processor 130 performs the computation and control functions of the controller 128, and may comprise any type of processor or multiple processors, single integrated circuits such as a microprocessor, or any suitable number of integrated circuit devices and/or circuit boards working in cooperation to accomplish the functions of a processing unit. During operation, the processor 130 executes one or more programs 140 contained within the memory 132 and, as such, controls the general operation of the controller 128 and the computer system of the controller 128, generally in executing the processes described herein, such as the processes discussed further below in connection with FIGS. 2 and 3. While the processor 130 is depicted in FIG. 1 as being part of the controller 128, it will be appreciated that in certain embodiments the processor 130 (and/or one or more additional processors) may also be part of various other vehicle components, such as (by way of example) one or more vehicle modules 108 (e.g., an engine control unit), sensors 122, drive system 118, transceiver 126, and so on.

The memory 132 can be any type of suitable memory. For example, the memory 132 may include various types of dynamic random access memory (DRAM) such as SDRAM, the various types of static RAM (SRAM), and the various types of non-volatile memory (PROM, EPROM, and flash). In certain examples, the memory 132 is located on and/or co-located on the same computer chip as the processor 130. In the depicted embodiment, the memory 132 stores the above-referenced program 140 along with one or more stored values 142 (e.g., including, in various embodiments, a local ledger comprising various data objects, such as a data blockchain, for the vehicle 100 and the peer network 104).

The bus 138 serves to transmit programs, data, status and other information or signals between the various components of the computer system of the controller 128. The interface 134 allows communication to the computer system of the controller 128, for example from a system driver and/or another computer system, and can be implemented using any suitable method and apparatus. In one embodiment, the interface 134 obtains the various data from the sensors 122, vehicle modules 108, and/or transceiver 126. The interface 134 can include one or more network interfaces to communicate with other systems or components. The interface 134 may also include one or more network interfaces to communicate with technicians, and/or one or more storage interfaces to connect to storage apparatuses, such as the storage device 136.

The storage device 136 can be any suitable type of storage apparatus, including various different types of direct access storage and/or other memory devices. In one exemplary embodiment, the storage device 136 comprises a program product from which memory 132 can receive a program 140 that executes one or more embodiments of one or more processes of the present disclosure, such as those set forth in FIGS. 2 and 3 and discussed below. In another exemplary embodiment, the program product may be directly stored in and/or otherwise accessed by the memory 132 and/or a disk (e.g., disk 144), such as that referenced below.

The bus 138 can be any suitable physical or logical means of connecting computer systems and components. This includes, but is not limited to, direct hard-wired connections, fiber optics, infrared and wireless bus technologies. During operation, the program 140 is stored in the memory 132 and executed by the processor 130.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 130) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 128 may also otherwise differ from the embodiment depicted in FIG. 1, for example in that the computer system of the controller 128 may be coupled to or may otherwise utilize one or more remote computer systems and/or other control systems.

FIG. 2 is a block diagram 200 of modules of the vehicle 100 of FIG. 1, including the control system 102 of FIG. 1 along with steps implemented by the modules, in accordance with exemplary embodiments. As shown in FIG. 2, the vehicle 100 includes a system manager module 201 (e.g., corresponding to the controller 128 of FIG. 1), along with the vehicle modules 108, vehicle bus 110, sensors 122, sensor interface 124, and transceiver 126 of FIG. 1. In various embodiments, the transceiver 126 may be referred to as a communication module 221, and the vehicle bus 110 and sensor interface 124 may collectively comprise and/or be coupled to a vehicle interface module 219. Also as depicted in FIG. 2, the system manager module 201 (i) communicates with the peer network 104 via the transceiver 126; (ii) communicates with the sensors 122 via the sensor interface 124; and (iii) communicates with the vehicle modules 108 via the vehicle bus 110 (e.g., one or more vehicle CAN buses).

As depicted in FIG. 2, in various embodiments, the vehicle 100 includes various modules 108 (from FIG. 1) that may include, by way of examples depicted in FIG. 2, a brake control module 202, an engine control unit (ECU) module 204, a transmission control module 206, an instrument pack module 208, a lighting module 210, and a climate control (e.g., HVAC) module 212, among other possible vehicle modules 108. In addition, as depicted in FIG. 2, in various embodiments, the system manager module 201 communicates with the vehicle modules 108 via multiple vehicle buses 110, including a low-speed bus 214 and a high-speed bus 216. For example, as depicted in FIG. 2, in certain embodiments, the system manager module 201 communicates with certain modules 108 (e.g., the instrument pack module 208, the lighting module 210, and the climate control module 212) via the low-speed bus 214, and communicates with certain other modules 108 (e.g., the brake control module 202, the ECU module 204, and the transmission control module 206) via the high-speed bus 216.

Also as depicted in FIG. 2, in various embodiments, the sensors 122 include infrared sensors 222, radar sensors 224, and camera sensors 226, among various other sensors 122 (e.g., pertaining to the various modules 108). Also as shown in FIG. 2, in various embodiments, the system manager module 201 communicates with the various sensors 122 via the sensor interface 124.

In addition, also as depicted in FIG. 2, in various embodiments, the system manager module 201 communicates with the peer network 104 via the transceiver 126 of FIG. 1 (e.g., a communication module) for maintaining, sharing, and updating data across the various participants using a distributed ledger technology (DLT) (e.g., in certain embodiments, a blockchain technology).

As described in greater detail below, the system manager module 201 (e.g., utilizing the processor 130 of the controller 128 of FIG. 1) controls communications with the peer network 104, gathers data from the peer network 104 as well as the vehicle modules 108 and sensors 122, validates the messages from the peer network 104, transforms the data into data objects (e.g., data blocks) that are consumable by the DLT of the peer network 104, controls the transmitting of the transformed data via the posting of messages from the vehicle 100 to the peer network 104, receives new information from the peer network 104 (including data pertaining to operation of the vehicle 100), and utilizes the received information to update a local ledger of the vehicle 100 and implement the messages for controlling various vehicle actions, for example via instructions provided to the vehicle modules 108, in various embodiments.

As depicted in FIG. 2, in various embodiments, the system manager module 201 includes an object manager module 220, an object encoding module 230, and an object decoding module 240. In certain embodiments, these modules correspond to modules of the processor 130 of FIG. 1.

In various embodiments, the object manager module 220 receives data from the vehicle modules 108, the sensors 122, the object encoding module 230, and the object decoding module 240, and maintains a set of data objects 250. In certain embodiments, the data objects 250 comprises a data block of a data blockchain (and is referred to herein as “blockchain 250”); however, this may vary in certain other embodiments (and, for example, may comprise one or more other types of data messages for one or more different types of DLT technology).

In various embodiments, the object encoding module 230 identifies data (step 232). For example, in various embodiments, the object encoding module 230 takes data that has been received via the object manager module 220 from the vehicle modules 108, the sensors 122, and/or the peer network 104, and identifies such data based on various data categories (e.g., based on different vehicle modules 108 and/or vehicle functionality, and/or various other types of data and/or usage thereof, in certain embodiments). In certain embodiments, this step is performed by the object encoding module 230 via the processor 130 of FIG. 1. Also in certain embodiments, the data is identified into categories that include the following: (i) safety critical data; (ii) beyond line-of-sight (BLOS) data; (iii) and public data.

For example, in certain embodiments, safety critical data may include, among other types of data: (a) from infrastructure to vehicle communications, data such as the infrastructure being in a failed state, a construction zone update or shift, and so on; (b) from within-vehicle communication, such as with autonomous vehicles, data such as a hard brake is engaged, a road surface irregularity, and so on; and (c) from vehicle to vehicle communications, data that a vehicle has been tampered with, vehicle operation in an unsafe manner, an identity security or trust issue, and so on.

Also by way of example, in certain embodiments, beyond line-of-sight (BLOS) data may include, among other types of data: (a) from infrastructure to vehicle communications, data indicating on road ahead and/or at specific coordinates (latitude/longitude), and so on; (b) from within-vehicle communication, such as with autonomous vehicles, data such as objects and/or information obscured by vehicles and/or outside of lane curvature; and (c) from vehicle to vehicle communications, data within a unit distance (e.g., locally based).

Also by way of example, in certain embodiments, public data may include, among other types of data: (a) from infrastructure to vehicle communications, data that is observable by an individual and/or maintained by the public sector; (b) from within-vehicle communication, such as with autonomous vehicles, data that is observable by the public and/or available to all, such as data that is available to all original equipment manufacturers (OEM) and capable systems; and (c) from vehicle to vehicle communications, data that is safety-necessitated to the public and/or available to all original equipment manufacturers (OEM) and capable systems.

Also in various embodiments, at step 234, the object encoding module 230 creates a data object. In various embodiments, the received data from step 232 is transformed into the data object. In certain embodiments, the data object comprises a data block, for a data blockchain for or comprising a local data ledger for the vehicle 100. In certain other embodiments, one or more other data objects may be generated, for example one or more data messages consistent with other DLT technologies. In various embodiments, the system manager module 201 creates the data object (e.g., the data block) based on the various data received (e.g., from the vehicle modules 108, the sensors 122, and the peer network 104), and based on the identification of the data from step 232. In certain embodiments, this step is performed by the object encoding module 230 via the processor 130 of FIG. 1.

Also in certain embodiments, the object encoding module 230 publishes the data objects (e.g., the data blocks) at step 236. For example, in certain embodiments, the object encoding module 230 directs the transceiver 126 to publish the data objects to the peer network 104. Also in certain embodiments, the data objects (e.g., data blocks) are also provided to the object manager module 220 for processing, for use in updating the local ledger for the vehicle 100. In various embodiments, the local ledger is updated so that the data object (e.g., data block) at issue should be on future copies (e.g., of the blockchain) that are received from the peer network 104 and/or from the vehicle 100. In various embodiments, the data object is provided to the transceiver 126, which sends the data object to an address or range of addresses in the peer network 104 (e.g., based on instructions provided by a processor, such as the processor 130 of FIG. 1). In various embodiments, the peer network 104 will subsequently send a response back to the transceiver 126 with an updated version of the distributed ledger (DL) for a version of the ledger that the peer network 104 would like to, effectively, update the system manager module 201 (e.g., which may be included in certain communications from the peer network 104 to the transceiver during step 242, discussed further below). In certain embodiments, the steps of step 326 (including the instructions therefor) are performed by the object encoding module 230 via the processor 130 of FIG. 1.

In certain embodiments, the object manager module 220 utilizes the data objects from the object encoding module 230 (along with other data objects from the object decoding module 240, as described below) to form and maintain a set of data objects 250 as shown in FIG. 2. In certain embodiments, the set of data objects 250 comprises a blockchain (and is hereafter referred to as blockchain 250) for a blockchain data network for the vehicle 100 and the peer network 104. However, it will be appreciated that in certain other embodiments, one or more other sets of data objects (e.g., data messages) may be utilized that are compatible with one or more other distributed ledger technologies. As shown in FIG. 2, in certain embodiments, the blockchain 250 includes a plurality of messages 252 (or data objects). In certain embodiments, each message 252 includes an identifier pertaining to the identification of step 232, as well as data corresponding to the data objects (e.g., blocks) of step 234, as well as data received from the object decoding module 240 (described below).

Also as depicted in FIG. 2, in various embodiments, the object decoding module 240 receives and checks messages from the peer network (step 242). In various embodiments, the object decoding module 240 receives messages from the peer network 104 via the transceiver 126. Also in various embodiments, the messages received from the peer network 104 include information pertaining to operation of the vehicle 100 and/or data for use in updating the local ledger of the vehicle 100. Also in various embodiments, as part of step 242, the object decoding module 240 checks the validity of the messages, and also checks the blockchain 250 for analogous information. For example, in certain embodiments, the object decoding module 240 confirms that the data from the peer network 104 is from a valid and trusted source. Also in certain embodiments, the object decoding module 240 also compares the received data from the peer network 104 with data from the blockchain 250, for example, to confirm that the data from the peer network 104 applies to a similar location, event, or circumstances as the data from the blockchain 250 for the vehicle 100 (e.g., as to whether the data from the peer network 104 is consistent to the data from the vehicle 100 as reflected in the local ledger, and so on). In certain embodiments, these steps are performed by the object encoding module 230 via the processor 130 of FIG. 1.

Also as depicted in FIG. 2, in various embodiments, at step 244, the object decoding module 240 updates the data and stores the updated data on the local ledger. For example, in certain embodiments, the data received from the peer network 104 is transformed into a data object (e.g., a data block) for adding one or more new messages 252 to the blockchain 250, and/or for updating one or more existing messages 252 of the blockchain 250, to include the additional information from the messages received from the peer network 104 at step 242 (along with any other new information from the vehicle 100, for example from the sensors 122 thereof). In certain embodiments, these steps are performed by the object decoding module 240 via the object manager module 220 of FIG. 1, for example via the processor 130 of FIG. 1.

In addition, in various embodiments, the blocks are read at step 246. In certain embodiments, the data from the updated blocks from step 244 is read and implemented at step 246. In various embodiments, the object decoding module 240 provides the information from the read blocks to the object manager module 220, which (i) further updates the blockchain 250 according to the read blocks (as well as additional information from the vehicle, such as the sensor data); and (ii) provides instructions for one or more vehicle actions (e.g., braking control, engine control, transmission control, climate control, lighting control, instrument pack control, and so on) to the vehicle modules 108 accordingly as appropriate. In certain embodiments, the vehicle actions are implemented based in part on whether the incoming data from the peer network 104 is from a verified source, and/or if not whether a recommendation from the incoming data from the peer network 104 is verified by sensor data from the vehicle 100, for example as discussed in greater detail further below in connection with an exemplary implementation of FIG. 3. In various embodiments, these steps are performed by the object decoding module 240 and the object manager module 220 of FIG. 1 via the processor 130 of FIG. 1.

FIG. 3 is a block diagram of exemplary hardware connectivity 302 and process flow 304 for the control system of FIGS. 1 and 2, in accordance with exemplary embodiments. Specifically, for illustrative purposes, the hardware connectivity 302 and process flow 304 are depicted in FIG. 3 with respect to an incoming braking event message 306 (e.g., pertaining to an automatic braking event or recommendation therefor) received from the peer network 104. For example, in certain embodiments, the braking event message 306 may pertain to automatic braking that is occurring or imminent for one or more nearby vehicles, and/or a recommendation for automatic braking for the vehicle 100 of FIGS. 1 and 2 (e.g., if there is another vehicle or other object that may otherwise contact, approach, and/or intersect a path of the vehicle 100, or the like). However, it will be understood that the connectivity and process flow would similarly apply to various other types of messages from the peer network 104.

As shown in FIG. 3, in terms of hardware connectivity 302, in various embodiments, the braking event message 306 is received by the transceiver 126, and is provided by the transceiver 126 to the system manager module 201 (e.g., via the controller 128 of FIG. 1). Also in various embodiments, information and instructions pertaining to the braking event message 306 are provided via the vehicle bus 110 to the engine control unit (ECU) 204 (e.g., one of the vehicle modules 108), which also receives information from the sensor interface 124 (e.g., information from the sensors 122, such as information as to any detected objects, speed and/or velocity of the vehicle 100, road conditions, and/or other information that may be relevant to automatic braking). Also as shown in FIG. 3, in various embodiments, the ECU module 204 processes the various information to generate braking instructions, and provides the braking instructions for the brake control module 202 for implementation by the brake control module 202.

With further reference to FIG. 3, in terms of process flow 304, the braking event message 306 is received at step 310. In various embodiments, the braking event message 306 is received by the transceiver 126.

At step 312, information is obtained from the local blockchain 250 of the vehicle 100, and the incoming braking event message 306 is verified. In various embodiments, the braking event message 306 is verified based on whether a source of the braking event message 306 (e.g., one of the other participants 106 of the peer network 104 of FIG. 1) is a valid and trusted source (e.g., similar to step 242 of FIG. 2). Also in certain embodiments, the braking event message 306 may also be verified based at least on part on the messages 252 of the local blockchain 250, for example as to whether the braking event message 306 is compatible with a current location, event, and/or circumstances for the vehicle 100 (also similar to step 242 of FIG. 2).

If it is determined at step 312 that the incoming braking event message 306 is verified (e.g., that the braking event message 306 is from a known and trusted source, and in certain embodiments also based on whether the braking event message 306 applies to the vehicle 100's current location and circumstances, in certain embodiments), then the incoming braking event message 306 is labelled as verified, and the process proceeds directly to step 316. Conversely, if the incoming braking event message 306 is not verified, then the incoming braking event message 306 is labelled as unverified at step 314, and then the process proceeds to step 316. In certain embodiments, steps 312 and 314 are performed by the system manager module 201, for example by the object decoding module 240 of FIG. 2 via the processor 130 of FIG. 1.

During step 316, the incoming braking event message 306 is decrypted. In certain embodiments, during step 316, data from the incoming braking event message 306 is read and stored on the local ledger. In various embodiments, the data from the incoming braking event message 306 (e.g., as to the circumstances or recommendations for a related braking event) is provided to the vehicle bus 110, along with an indication as to whether the incoming braking event message 306 has been labelled as verified in step 312. Also in certain embodiments, the local blockchain 250 may be updated based on the data (e.g., if the incoming braking event message 306 has been labelled as verified), for example based on the data from the braking event message 306. In certain embodiments, these steps are performed by the system manager module 201, for example by the object decoding module 240 and the object manager module 220 of FIG. 1, for example via the processor 130 of FIG. 1.

The incoming braking event message 306 is processed at step 318. Specifically, in various embodiments, a determination is made at step 318 as to whether an automatic braking action for the vehicle 100 is warranted, based on the incoming braking event message 306. For example, in certain embodiments, an automatic braking action may be warranted if the incoming braking event message 306 includes a recommendation for automatic braking for the vehicle 100 and/or includes information revealing that automatic braking would be appropriate (e.g., if the information reveals that the vehicle 100 may otherwise imminently contact another vehicle, infrastructure, or other object). Also in various embodiments, in such instances in which automatic braking is warranted (e.g., either as directly stated in the incoming braking event message 306 and/or deduced based on information therefrom as to circumstances surrounding the vehicle 100), then a vehicle 100 braking instruction is generated at step 318. In certain embodiments, this step is performed by one of the vehicle modules 108 (e.g., the ECU module 204), and/or via a processor (such as the processor 130 of FIG. 1).

In certain embodiments, the implementation of such an instruction from step 318 is dependent at least in part based on whether the braking event message 306 is labelled as verified in step 312. For example, in certain embodiments, if the braking event message 306 is labelled as verified (from step 312), then the process automatically proceeds to step 322, as the braking instruction is implemented. For example, in various embodiments, the brake control module 202 implements instructions from the vehicle ECU module 204 (e.g., via a processor) to actuate one or more brakes for the vehicle 100, to thereby initiate automatic braking.

Conversely, also in certain embodiments, if the braking event message 306 is labelled as unverified (from step 314), then the process instead proceeds to step 320. During step 320, the braking instruction that was deduced (either directly or indirectly) from the incoming braking event message 306 is verified with sensor data (e.g., from various sensors 122 of FIGS. 1 and 2). In certain embodiments, this verification is performed by one of the vehicle modules 108 (e.g., the ECU module 204), and/or via a processor (such as the processor 130 of FIG. 1). Also in certain embodiments, if the sensor data is determined to be consistent with (or supports) the braking instruction, then the braking instruction is implemented in step 322 (e.g., in the manner discussed above). Otherwise, if the sensor data is determined to be inconsistent with (or does not support) the braking instruction from the unverified incoming braking event message 306, then the braking instruction is not implemented, in various embodiments.

In various embodiments, the various steps of the process may continue throughout a current vehicle drive or ignition cycle, and then terminate upon completion thereof.

While FIG. 3 is discussed in connection with a particular type of instruction and associated functionality (i.e., a braking command), it will be appreciated that in various embodiments similar steps would also apply to various other types of instructions and associated functionality (e.g., automatic steering, automatic climate control, automatic engine control, automatic transmission control, automatic entertainment and/or infotainment control, automatic lighting control, automatic instrument pack control, and so on).

Accordingly, methods, systems, and vehicles are provided for controlling and implementing communications between a vehicle 100 and a peer network 104. In various embodiments, the vehicle 100 utilizes distributed ledger technology in receiving, sharing, updating, and implementing information regarding the vehicle 100 along with other participants 106 such as other vehicles, infrastructure, intelligent systems (e.g., IOT), server systems, cloud systems, and the like.

In various embodiments, the control system 102 receives data from the peer network 104, transforms the data into a data object (e.g., a data block) that is consumable by a DLT of the peer network 104, transmits the transformed data to the peer network 104, and receives new information from the peer network 104 that is used to update a local ledger on a vehicle as well as to implement one or more vehicle actions for the vehicle 100. In certain embodiments, a blockchain technology is utilized; however, in other embodiments other distributed ledger technologies may be utilized. In various embodiments, the vehicle 100 receives incoming data messages from the other participants 106 and verifies the messages and/or their source. Also in various embodiments, the vehicle 100 implements recommendations from the messages in vehicle actions via one or more vehicle modules 108, for example after verifying recommendations using vehicle sensor data if the source of the message is not verified as being a known and trusted source. Also in various embodiments, the vehicle 100 publishes its own data messages (e.g., from vehicle 100 sensor data) for the peer network 104, and maintains a local ledger (e.g., as a blockchain of messages) based on the vehicle sensor data and the messages received from the peer network 104.

It will be appreciated that the systems, vehicles, and methods may vary from those depicted in the Figures and described herein. For example, the vehicle 100, the control system 102, the vehicle modules 108, and/or the modules and/or components thereof of FIGS. 1-3 may vary in different embodiments. It will similarly be appreciated that the steps of the processes of FIGS. 2 and 3 may differ from those depicted in FIGS. 2 and/or 3, and/or that various steps may occur concurrently and/or in a different order than that depicted in FIGS. 2 and 3, in various embodiments. It will also be appreciated that, in various embodiments, the various steps of the processes set forth in FIGS. 2 and 3 are automatically performed via instructions by a computer processor, such as the processor 130 of FIG. 1.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof

What is claimed is:

1. A method comprising:
receiving sensor data pertaining to operation of a vehicle, via one or more sensors that are disposed onboard the vehicle;
receiving, using distributed ledger technology (DLT), peer network data, via a transceiver that is onboard the vehicle, from a peer network having, as actors, the vehicle as well as a plurality of other actors that are disposed remote from the vehicle, and that together form the peer network; and
taking a vehicle action for the vehicle, via instructions provided by a processor that is disposed onboard the vehicle, using the peer network data and the sensor data.

2. The method of claim 1, further comprising:
generating, via the processor, a data object using the sensor data; and
posting the data object on the peer network, via the transceiver, in accordance with further instructions provided by the processor.

3. The method of claim 1, wherein the step of taking the vehicle action comprises taking automatic control of one or more vehicle modules, via the instructions provided by the processor based on the peer network data and the sensor data.

4. The method of claim 1, further comprising:
verifying a source of the peer network data from the plurality of other actors; and
wherein the step of taking the vehicle action comprises taking the vehicle action based also on the verifying of the source of the peer network data.

5. The method of claim 4, wherein the step of taking the vehicle action comprises:
determining a recommended vehicle action from the peer network data; and
wherein the step of taking the vehicle action comprises:
if the source of the peer network data comprises a verified source, then automatically implementing the recommended vehicle action, via the instructions provided by the processor; and
if the source of the peer network comprises an unverified source, then:
determining whether the recommended vehicle action is consistent with the sensor data; and
implementing the recommended vehicle action on a further condition that the recommended vehicle action is consistent with the sensor data.

6. The method of claim 1, further comprising:
transforming the peer network data into a data object, via the processor; and
updating a local ledger on a memory that is disposed onboard the vehicle using the data object, via the instructions provided by the processor.

7. The method of claim 6, wherein:
the step of transforming the peer network data into the data object comprises transforming the peer network data into a data block, via the processor; and
the step of updating the local ledger comprises updating a local copy of the ledger/blockchain on the memory that is disposed onboard the vehicle using the data block, via the instructions provided by the processor.

8. A system comprising:
a vehicle interface module configured to receive sensor data pertaining to operation of a vehicle, via one or more sensors that are disposed onboard the vehicle;
a communication module configured to receive, using distributed ledger technology (DLT), peer network data, via a transceiver that is onboard the vehicle, from a peer network having, as actors, the vehicle as well as a plurality of other actors that are disposed remote from the vehicle, and that together form the peer network; and
a manager module configured to take a vehicle action for the vehicle, via instructions provided by a processor that is disposed onboard the vehicle, using the peer network data and the sensor data.

9. The system of claim 8, wherein the manager module is configured to:
generate, via the processor, a data object using the sensor data; and
provide further instructions to post the data object on the peer network, via the communication module.

10. The system of claim 8, wherein the manager module is configured to take automatic control of one or more vehicle modules, via the instructions provided by the processor based on the peer network data and the sensor data.

11. The system of claim 8, wherein the manager module is configured to:
verify a source of the peer network data from the plurality of other actors; and
take the vehicle action based also on the verifying of the source of the peer network data.

12. The system of claim 11, wherein the manager module is configured to:
determine a recommended vehicle action from the peer network data;
if the source of the peer network data comprises a verified source, then automatically implement the recommended vehicle action, via the instructions provided by the processor; and
if the source of the peer network comprises an unverified source, then:
determine whether the recommended vehicle action is consistent with the sensor data; and
implement the recommended vehicle action on a further condition that the recommended vehicle action is consistent with the sensor data.

13. The system of claim 8, wherein the manager module is configured to:
transform the peer network data into a data object, via the processor; and
update a local ledger on a memory that is disposed onboard the vehicle using the data object, via the instructions provided by the processor.

14. The system of claim 13, wherein the manager module is configured to:
transform the peer network data into a data block, via the processor; and
update a blockchain on the memory that is disposed onboard the vehicle using the data block, via the instructions provided by the processor.

15. A vehicle comprising:
a body;
a propulsion system configured to generate movement of the body;
one or more sensors that are disposed onboard the vehicle and configured to provide sensor data pertaining to operation of the vehicle;
a transceiver that is disposed onboard the vehicle and configured to receive, using distributed ledger technology (DLT), peer network data from a peer network having, as actors, the vehicle as well as a plurality of other actors that are disposed remote from the vehicle, and that together form the peer network; and
a processor that is disposed onboard the vehicle and configured to provide instructions for taking a vehicle action for the vehicle using the peer network data and the sensor data.

16. The vehicle of claim 15, wherein the processor is configured to:
generate a data object using the sensor data; and
provide instructions to post the data object on the peer network via the transceiver.

17. The vehicle of claim 15, wherein the processor is configured to take automatic control of one or more vehicle modules based on the peer network data and the sensor data.

18. The vehicle of claim 15, wherein the processor is configured to:
verify a source of the peer network data from the plurality of other actors;
determine a recommended vehicle action from the peer network data;
if the source of the peer network data comprises a verified source, then automatically implement the recommended vehicle action; and
if the source of the peer network comprises an unverified source, then:
determine whether the recommended vehicle action is consistent with the sensor data; and
implement the recommended vehicle action on a further condition that the recommended vehicle action is consistent with the sensor data.

19. The vehicle of claim 15, wherein the processor is configured to:
transform the peer network data into a data object; and
provide instructions to update a local ledger on a memory that is disposed onboard the vehicle using the data object.

20. The vehicle of claim 19, wherein the processor is configured to:
transform the peer network data into a data block; and
provide instructions to update a blockchain on the memory that is disposed onboard the vehicle using the data block.
